(19) United States
(12) Patent Application Publication
(10) Pub. No.: US 2009/0279872 A1
(43) Pub. Date: Nov. 12, 2009

(54) CONTENT DATA OUTPUT DEVICE, TELEVISION CONTAINING SAME, AND CONTENT DATA OUTPUT PROGRAM

(76) Inventors: Azusa Umemoto, Kyoto (JP); Katsuya Nakagawa, Kyoto (JP)

Correspondence Address: BIRCH STEWART KOLASCH & BIRCH, PO BOX 747, FALLS CHURCH, VA, 22040-0747, US

(21) Appl. No.: 12/092,407

(22) PCT Filed: Oct. 30, 2006
(86) PCT No.: PCT/JP2006/321631

§ 371 Date: May 1, 2008

(30) Foreign Application Priority Data
Nov. 2, 2005 (JP) 2005-320020

(51) Int. Cl. H04N 7/26; H04B 7/00

(52) U.S. Cl. 386/124; 455/41.2

(57) ABSTRACT

The content data output device of the present invention includes: an IrDA receiving section (13) for receiving content data; and a second input switching section (14) for storing the content data received by the IrDA receiving section (13) and implementing such control as to output the recorded content data in preference to other data. Therefore, the content data can be output by simply transmitting the content data to the data output device. The user is required no operation at all on the data output device.

### TECHNICAL FIELD

The present invention relates to a content data output device enabling viewing of content data, a television containing the device, and a content data output program.

### BACKGROUND ART

There is conventional technology by which to connect a digital camera, a mobile phone, or a like device to a personal computer or a like device and reproduce still images, moving images, and other content, data created on the digital camera or the mobile phone for viewing and editing on a monitor for the personal computer. Japanese Unexamined Patent Publication (Tokukai 2000-33191; published Mar. 21, 2000) discloses a technique of automatically displaying an image on a television screen for image processing when a digital camera or a memory card is connected or inserted into a device connected to the television, the display being triggered by the connection or the insertion. Japanese Unexamined Patent Publication (Tokukai 2000-261750; published Sep. 22, 2000) discloses a technique of always enabling reproduction of the broadcast content the user is either viewing or has viewed and permanent recording of the content. Japanese Unexamined Patent Publication (Tokukai 2002-10227; published Jan. 11, 2002) discloses a technique of transferring an image from a storage terminal to a wide screen device for display and viewing.

### DISCLOSURE OF INVENTION

With Tokukai 2000-83191, the user has to connect or insert the digital camera or the memory card to the device connected to the television. The memory card is even more troublesome because the user has to also remove it from the digital camera.

The present invention, conceived in view of these problems, and has objectives of providing a content data output device, as well as a television containing the content data output device, which enables viewing of content data without the user having to connect the device to a digital camera or other content data transmitting device and without the user having to perform special operation.

To solve the problems, the content data output device in accordance with the present invention is characterized in that it includes; content data receiving means for receiving content data; and content data control means for implementing such control as to record the content data received by the content data receiving means and outputting the recorded content data in preference to other data.

Here, the content data refers to general multimedia data including still images, moving images, sound, and text and in particular to multimedia data received from mobile phones, digital cameras, etc. on which still images and moving images are captured. The content data received by the content data receiving means docs not need to be recorded in the content data output device, but may be externally recorded.

The configuration enables the content data control means to output the content data received by the content data receiving means in preference to other data in response to the reception. Thus, the user has simply to transfer the content data to the content data output device to output the content data. The user does not need to perform any operations at all on the content data output device, much less connect the content data transmitting device to the content data output device. In addition, since the content data received by the content data receiving means is recorded first, the content data can be reproduced later.

### BRIEF DESCRIPTION OF DRAWINGS

FIG. 1 A schematic block diagram illustrating the configuration of a content data output device.

FIG. 2(a) An illustration showing a configuration in which a remote controller signal receiving section and an IrDA receiving section arc provided separately.

FIG. 2(b) An illustration showing a configuration in which a remote controller signal receiving section and an IrDA receiving section are provided integrally.

FIG. 3(a) A schematic illustration of a content data list, representing how content data is managed in a data storage section.

FIG. 3(b) A schematic illustration of a content data list, representing how content data is managed in a data storage section.

FIG. 3(c) A schematic illustration of a content data list, representing how content data is managed in a data storage section.

FIG. 4(a) A schematic illustration of the configuration of a remote controller.

FIG. 4(b ) An illustration of a channel list.

FIG. 4(c) An illustration of a channel list.

FIG. 5 A schematic flow chart showing operations of the content data output device.

FIG. 6 A flow chart illustrating processing of the received content data shown in FIG. 5.

FIG. 7 A flow chart illustrating a process of appending the received content data received to the content data list shown in FIG. 6.

FIG. 8 A flow chart illustrating a process of displaying the designated content data shown in FIG. 5.

FIG. 9 A flow chart illustrating a process of input switching shown in FIG. 5.

FIG. 10 A schematic illustration of how the television screen switches upon the transmission of an image to the content data output device.

FIG. 11(a) An illustration of a television equipped with a receiving section.

FIG. 11(b) An illustration of an adapter-installed television equipped externally with a receiving section in the form of an adapter.

FIG. 12 A flow chart illustrating the process flow shown in FIG. 5 with additional processing which is implemented in accordance with the status of the content data output device.

FIG. 13 A flow chart illustrating the specifics of the processing shown in FIG. 12.

FIG. 14 A flow chart illustrating the process flow shown in FIG. 9 with additional processing which involves the use of a GO BACK button.

FIG. 15 A flow chart illustrating a process which, following the processing shown in FIG. 13, undoes that processing by using the GO BACK button.

FIG. 16(a) An illustration of a slide show.

FIG. 16(b) An illustration of a slide show.

FIG. 16(c) An illustration of a slide show.

FIG. 17 Illustrates an example of display images for a list of groups and a list (thumbnails) of content found in one of the groups when there are more than, one content data list or the content data is classified and stored by group.

FIG. 18 An illustration of an on-screen display of a transmitter transmitting content data.

FIG. 19(a) An example of a screen simultaneously showing a plurality of sets of content data fed from the transmitter.

FIG. 19(b) An example of a screen sequentially showing the content data fed.

FIG. 20(a) An illustration of a favorite program table.

FIG. 20(b) An example of the screen displayed, when content data is received while viewing a favorite program.

FIG. 20(c) An example of the screen displayed when a favorite program is over if content data was received while viewing that favorite program.

FIG. 21(a) An illustration, of a receiving section capable of discriminating between an infrared beam that is incoming from the left and another that is incoming from the right.

FIG. 21(b) An illustration of a television equipped with two adapters to discriminate between the left/right infrared beams.

FIG. 21(c) An illustration of receiving sections being installed on the front of a television, one on the left and another on the right, to discriminate between the left/right infrared beams.

FIG. 21(d) An illustration of a television displaying a music program.

FIG. 21(e) An illustration of what happens to the television screen shown in FIG. 21(d) when an IrDA signal is received from the left.

FIG. 21(f) An illustration of what happens to the television screen shown in FIG. 21(d) when an IrDA signal is received from the right.

FIG. 22(a) shows a car navigation display as viewed from the assistant driver's seat; (b) shows a car navigation display as viewed from the driver's seat; (c) shows a display as viewed from the assistant driver's seat and the driver's seat when non-AV content data is received while the screen in FIG. 22(a) and that in FIG. 22(b) are being displayed; (d) shows a display as viewed from the assistant driver's scat when AV content is received while the screen in FIG. 22(c) is being displayed; and (e) shows a display as viewed from the driver's seat when AV content is received while the screen in FIG. 22(c) is being displayed.

### REFERENCE NUMERALS

1 Receiving Section (Content Data Receiving Means)

3 List Appending Section (Content Data Control Means)

4 Data Storage Section (Content Data Storage Means)

9 Output Section (Data Output Means)

13 IrDA Receiving Section (Content Data Receiving Means)

14 Second Input Switching Section (Content Data Control Means or Switching Means)

15 Content data list

21 Television

25 Adapter (Content Data Output Device)

### BEST MODE FOR CARRYING OUT INVENTION

An embodiment of the present invention will be described in reference to figures

### Configuration of Content Data Output Device

A content data output device (data output device) of the present embodiment is a device built on infrared transmission technology called “IrSimple,” a simplified protocol. The technology can transmit relatively large files between devices very quickly. Thanks to this transmission technology, the data output device can receive, from a mobile phone and other transmitters, the content data that will be output for display on a wide-screen television so that the user can enjoy it. The content data refers not only to still images, but also to moving images. The content data refers to multimedia data including still images, moving images, sound, and text. The content data may be a list which contains one or more pointer (reference) to multimedia data.

The content data does not have to be transmitted by IrSimple, It may be transmitted by IrDA or another optical communications scheme, or by radio communications technology, such as UWB (Ultra Wide-Band), Bluetooth, ZigBee, or a wireless LAN. Alternatively, a cradle may be used to which the transmitter is mounted. The cradle can connect to a television wirelessly, for example, by optical or radio communication or via cable, for example, by USB or IEEE 1394.

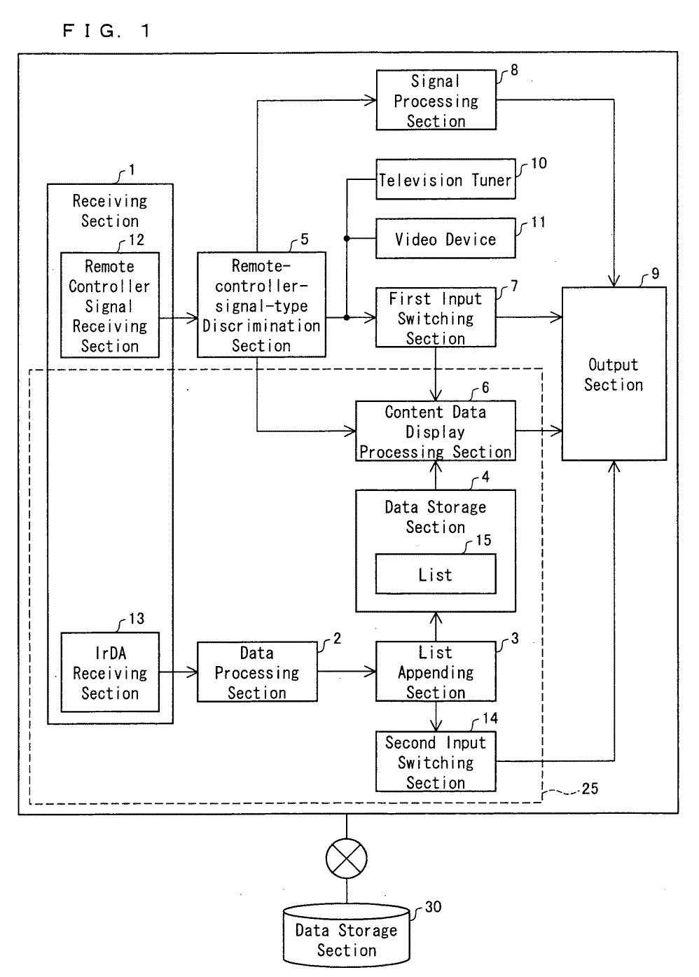

The data output device, as shown in FIG. 1, includes a receiving section (receive light section or content data receiving means) 1, a data processing section 2, a list appending section 3, a data storage section (content data storage means) 4, a remote-controller-signal-type discrimination section 5, a content data display processing section 6, a first input switching section 7, a signal processing section S, an output section 9, a television tuner 10, a video device 11, and a second input switching section, (switching means) 14, The output section 9 refers to, for example, the television monitor and speakers through which the content data is reproduced. The data output device may also include a radio tuner or a like tuner (not shown). The data output device includes also a content data control section (content data control means) that 13 made up of at least the list appending section 3 and the second input switching section 14. The minimum component (essential component) of the data output device is an adapter 25 indicated by a broken line in FIG. 1 (will be detailed later).

The data storage section 4 in the data output device may have only a minimum capacity required for minimum image display and overall control, in which case another data storage section 30 is provided outside the data output device as shown in FIG. 1. The data storage section 30 is, for example, a wire-connected external HDD (Hard Disk Drive), flash memory, or a like device. Alternatively, the data storage section 30 may be a server or storage connected over a network. Furthermore, the data output device may include no data, storage section 4, but only the external data storage section 30.

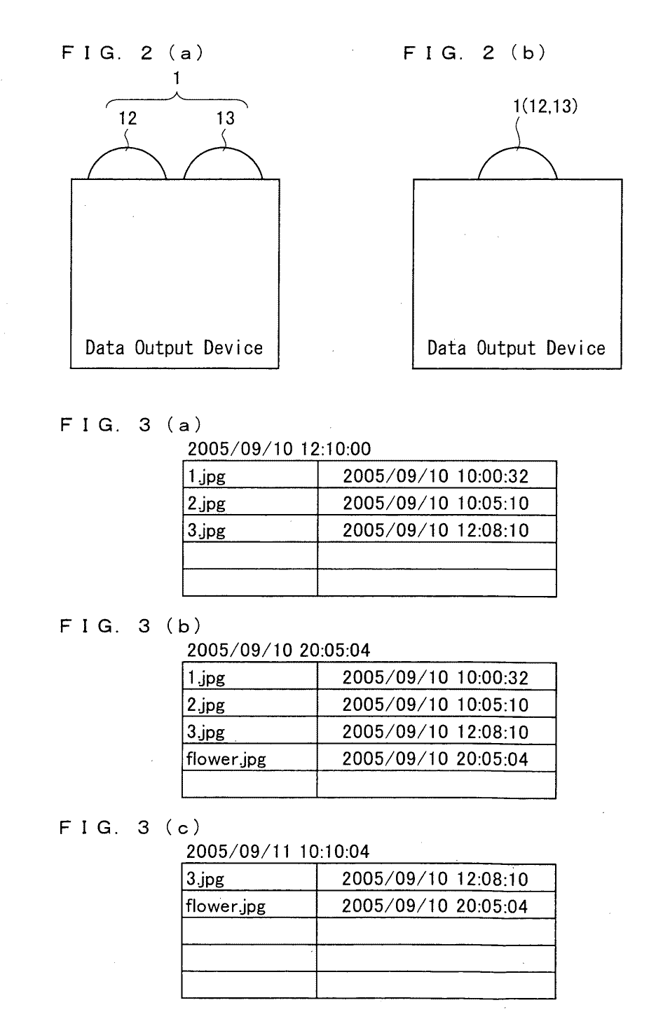

The receiving section 1 includes a remote controller signal receiving section (infrared beam receiving section) 12 and an IrDA receiving section (content data receiving means) 13 as shown in FIGS. 1 and 2(a). The section 12 receives a remote controller signal (command input signal) from a remote controller for a television or car navigation system and sends that signal to the remote-controller-signal-type discrimination section 5. The section 13 receives a content data signal from a mobile phone, etc. by IrSimple, IrDA, or other transmission technology and sends that signal to the data processing section 2.

Whether the signal received by the receiving section 1 is a remote controller signal or an IrDA signal is determined from whether the signal is received by the remote controller signal receiving section 12 or the IrDA receiving section 13. The remote controller signal receiving section 12 and the IrDA receiving section 13 may be constructed integrally in the receiving section 1, that is, as a single device (remote controller signal receiving section/IrDA receiving section), as shown in FIG. 2(b).

When the integral device approach is taken, whether the signal received by the receiving section 1 is a remote controller signal or an IrDA signal is determined from whether or not the signal passes through a bandpass filter. If the signal passes through the bandpass filter, it is a remote controller signal; if it does not pass, it is an IrDA signal. It is preferable to use the bandpass filter so that a remote controller signal can be fed to the remote-controller-signal-type discrimination section 5 and an IrDA signal can be fed to the data processing section 2. The integrally constructed receiving section 1 acts as the IrDA receiving section 13 if the incoming data is content data (data carried by the IrDA signal) and as the remote controller signal receiving section 12 if the incoming data is not content data. The bandpass filter may be set to, for example, about 20 to 60 kHz or about ±5% of carrier frequencies.

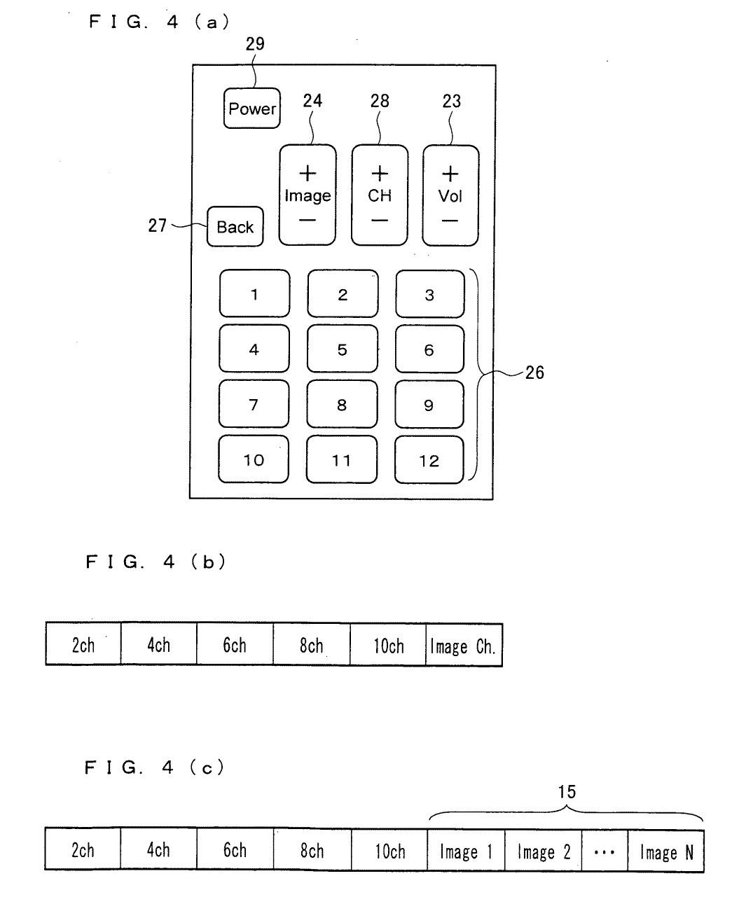

The data processing section 2 decompress the content data received from the IrDA receiving section 13 into a data format suitable for output from the output section 9 and implements other processing on the data, before feeding the data to the list appending section 3. If the content data needs no decompression or other processing, the data processing section 2 performs no processing on the data and simply relays the received content data to the list appending section 3. The list appending section 3 records the content data receded from the data processing section 2 to the data storage section 4 as a content data list 15. (see FIG. 4(c)), and sends the content data to the second input switching section 14.

The second input switching section 14, upon receiving the content data from the list appending section 3, instructs the output section 9 to switch the current display on output section 9 from television broadcast, video reproduction, etc. to the content data. Thus, as the content data is transmitted from the transmitter, the content data is displayed automatically (preferentially) without the user having to perform any operations at all on the data output device.

The remote-controller-signal-type discrimination section 5 receives the command input signal (command signal) received from the user by the remote controller signal receiving section 12, The remote-controller-signal-type discrimination section 5 determines if the received command signal is a content data specifying command signal, a switching signal (a channel switching signal and an input source switching signal), or none of these signals (will be detailed later). If the received command signal is determined to be a content data specifying command signal, the section 5 outputs the signal to the content data display processing section 6; if it is determined to be a switching signal, the section 5 outputs the switching signal to the first input switching section 7; and if it is determined to be none of these signals, the section 5 outputs the signal to the signal processing section 8. The first input switching section 7, when the content data has been selected by switching between channels, instructs the content data display processing section 6 to process the content data for display (sends a content data specifying command signal).

The content data display processing section 6 process the content data based on the content data specifying command signal received from the remote-controller-signal-type discrimination section 5 or the first input switching section 7 so that the content data can be displayed on the output section 9.

The first input switching section 7 switches either between input sources or channels based on the switching signal received from the remote-controller-signal-type discrimination section 5. The input source refers to, for example, the television broadcast received through the television tuner 10, the video obtained from the video device 11, the radio broadcast received through the radio tuner, and the content data received through the IrDA receiving section 13. As mentioned earlier, to switch to the content data, the content data specifying command signal is sent to the content data display processing section 6.

The signal processing section 8 processes signals for, for example, turning up or down the sound volume and specifying channel numbers received from the remote-controller-signal-type discrimination section 5.

The data storage section 4 contains the content data list 15 as shown in FIG. 1. The section 4 plays a role of storing the content data as the content data list 15.

If the data storage section 4 in the data output device (data presentation device) has too small a storage capacity, the content itself (files, etc.) may be stored in the data storage section 30 external to the data output device, whilst the data storage section 4 in the data output device may contain only the storage places (addresses, URIs, etc) of the content. Alternatively, the data storage section 4 in the data output device may contain only the data needed to draw graphics like an image after file decompression, the content cache that enables efficient reloading, etc. with the content data list 15 also being contained in the data storage section 30 provided external to the data output device.

FIGS. 3(a) to 3(c) are illustrations of the content data list 15 in the data storage section 4, representing how the content data is managed, Suppose, as shown in FIG. 3(a), that the data storage section 4 contains three images (content data), “1.Jpg,” “2.Jpg,” and “3.Jpg,” at 12:10:00 on Sep. 10, 2005. Later at 20:05:04 on Sep. 10, 2005, the content data of “flower.Jpg” is received and stored in the data storage section 4, and “flower.Jpg,” is appended to the content data list 15 as shown in FIG. 3(b). The figure shows that “flower.Jpg” is appended to the end of the content data list 15; this is not the only the possibility. For example, if “2.Jpg” is being displayed while receiving “flower.Jpg,” “flower.Jpg” may be inserted between “2.Jpg” and “3.Jpg.”

Meanwhile, the data storage section 4 has a limited storage capacity for the content data. Therefore, the content data control section of the present embodiment preferably has a content data erasing section (content data erasing means (not shown)) that monitors the content data list in the data storage section 4 and erases the content data in the data storage section 4 according to a predetermined set of conditions. The content data may be erased according to a command input from the user which specifies the content data to be erased.

Examples of the predetermined set of conditions are as follows: (i) erase a period after reception; (ii) erase the oldest content data when the total data size of the content data stored (sum of individual file sizes) exceeds a predetermined value; and (iii) erase the least frequently accessed content data when the total data size of the content data stored (sum of individual file sizes) exceeds a predetermined value. FIG. 3(c) shows an erasure rule, “Erase 24 Hours after Reception,” having being applied to the content data in FIG. 3(b). According to the erasure rule, the content data, “1.Jpg” and “2.Jpg,” that was received more than 24 hours ago has been erased as shown in FIG. 3(c).

Next will be described the configuration of the remote controller through which the user operates the television (content presentation device) containing the data output device. Referring to FIG. 4(a), the remote controller has a power supply button (Power) 29 for turning on/off the power supply for the television, a television channel button 23 for incrementing/decrementing the television channel, a sound volume button 23 for changing the sound volume, an image channel button 24 for incrementing/decrementing the image channel, a GO BACK button 27 (its functions will be detailed later), and a group of television channel buttons 26 allowing direct inputs of television channels, The remote controller for the television is not limited to this particular example, It may have a cross-shaped key or button allowing up/down/left/right inputs, a mouse allowing direct pointing, a touch pad, a toggle button, a jog shuttle, etc.

The remote controller is the same as a common television remote controller except that the image channel button 24 is included. The provision of the image channel button 24 enables the user to select among image channels (content data channels) like selecting among television channels. While watching an ordinary television program, the user can switch the display directly to an image channel by pressing cither “+” or “−” on the image channel button 24.

The channel list by which the television channel button 28 is managed is arranged as shown FIG. 4(b), If “Image Ch” is specified while sapping channels with the television channel button 28, content data can be selected from the content data list 15 using the image channel button 24. A alternative is shown in FIG. 4(c) where the channel list includes a content data list so that the user can select an image channel by zapping channels with the television channel button 28. In a case like this, the image channel button 24 is unnecessary because the user can use the television channel button 28 to switch between the image channels.

By pressing the GO BACK button 27 on the remote controller while viewing an image channel, the user can switch from the content data back to the previous television channel or video.

### Operation of Content Data Output Device

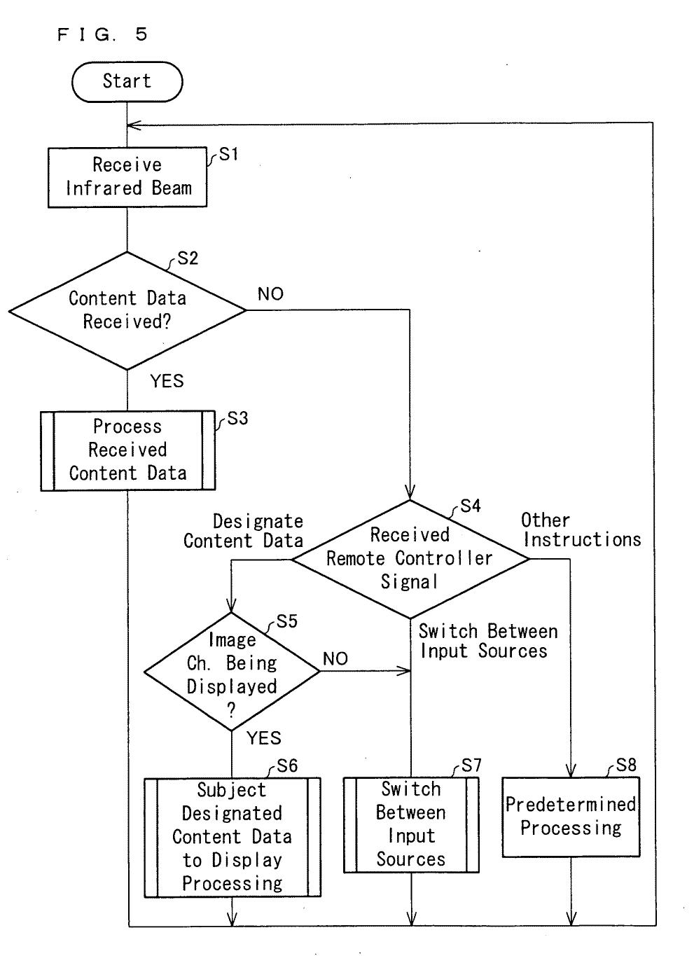

Now, the operation of the data output device will be described. FIG. 5 is schematic flow chart depicting the operation of the data output device.

First, as the receiving section 1 receives an infrared beam (S1), the section 1 determines whether the signal on the infrared beam is a remote controller signal or an IrDA signal (S2).

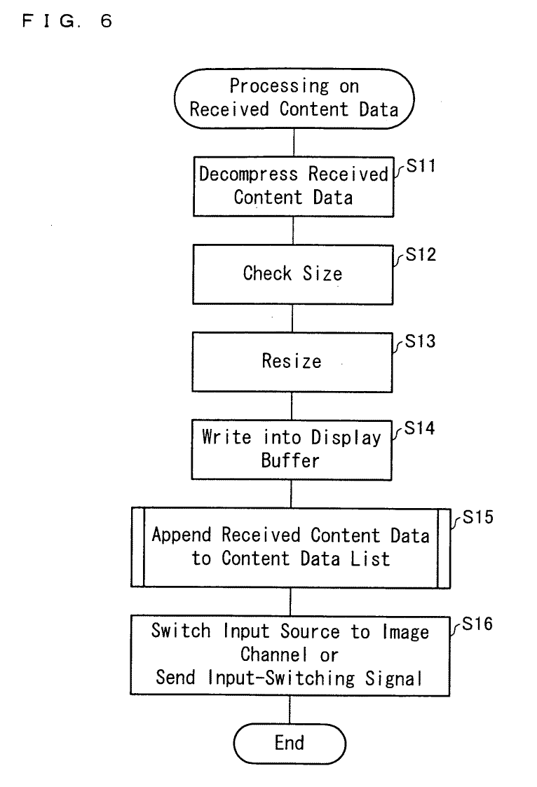

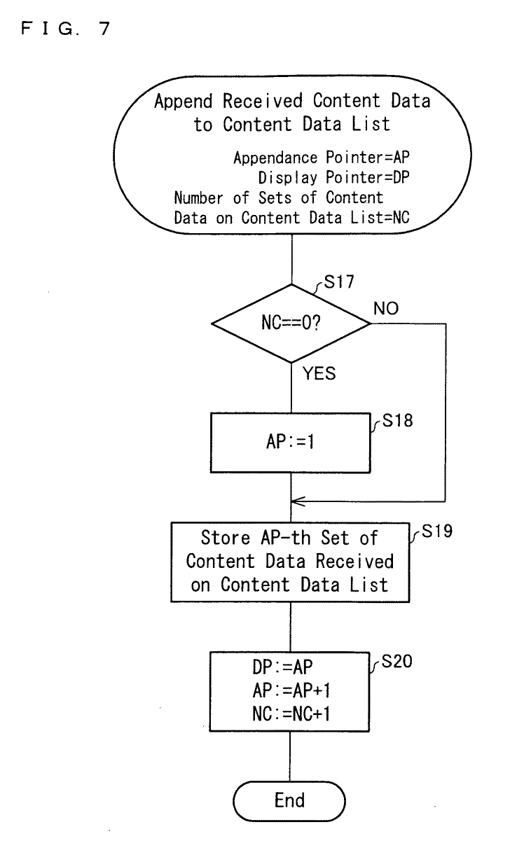

In other words, the receiving section 1 determines whether the received data is data transmitted by a remote controller signal or content data. In a case where the remote controller signal receiving section 12 and the IrDA receiving section 13 are integrated into a single device as shown in FIG. 2(b), a bandpass filter is used to distinguish between a remote controller signal and an IrDA signal. If the received signal is an IrDA signal (YES in S2), the section 1 feeds the IrDA signal to the data processing section 2. The data processing section 2, list appending section 3, and second input switching section 14 perform content data processing (see FIGS. 6 and 7) on the IrDA signal (S3),

On the other hand, if the received signal is a remote controller signal (NO in S2), the section 1 feeds the signal to the remote-controller-signal-type discrimination section 5 where the type of the remote controller signal is determined (S4). Specifically, the section 5 determines whether the remote controller signal is a content data specifying command signal, an input switching command signal (switching signal), or none of these signals. If the remote controller signal is a content data specifying command signal, that is, if “+” or “−” on the image channel button 24 is pressed, the remote-controller-signal-type discrimination section 5 determines whether the output section 9 is outputting content data, that is, whether the section 9 is displaying an image channel (S5).

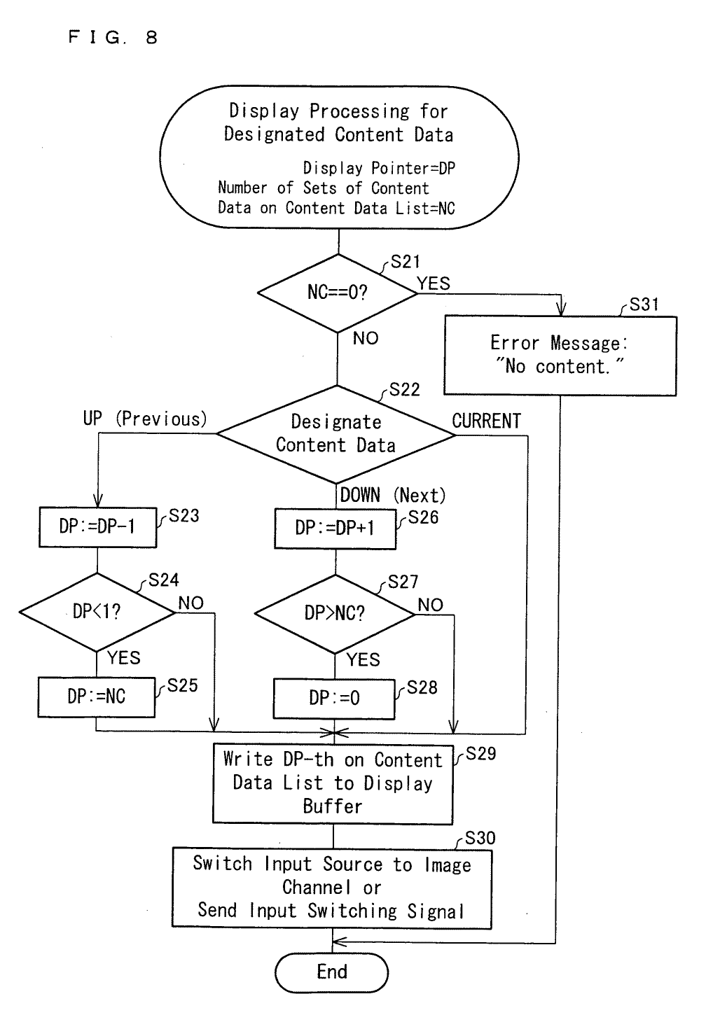

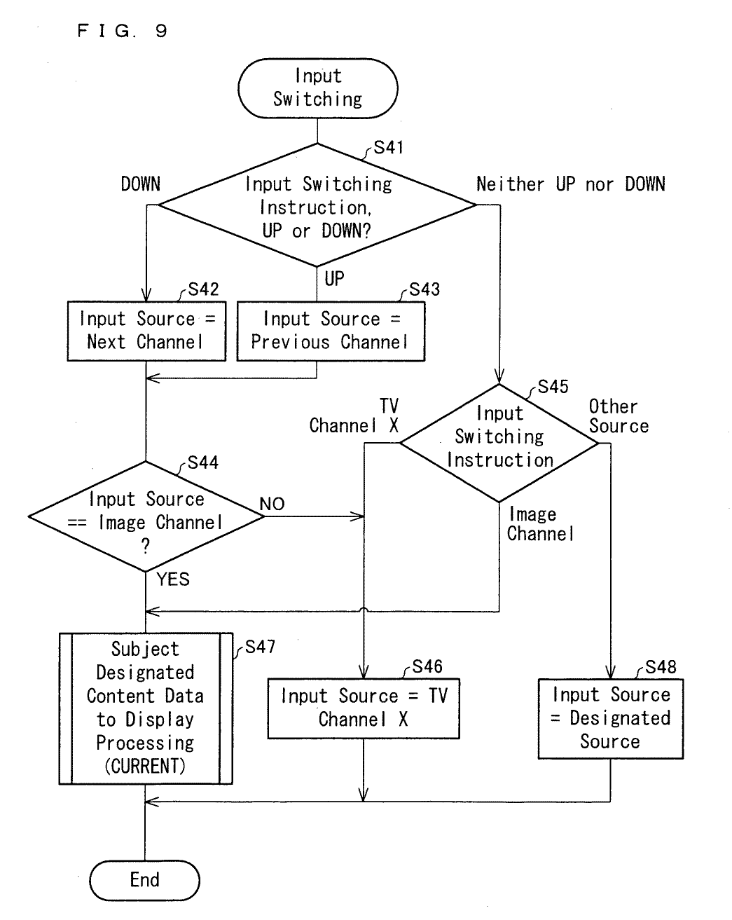

If the section 9 is outputting content data (YES in S5), designated content data display processing is performed (S6; see FIG. 8). On the other hand, if the section 9 is displaying no image (NO in S5), the first input switching section 7 performs input switching (S7; see FIG. 9). The first input switching section 7. performs the input switching also if the remote controller signal is a switching signal (S7). If the remote controller signal is none of these signals (for example, if it is a sound volume up/down signal or a channel number signal), the signal is processed according to the type of that signal (S8).

Alternatively, while the content data output device is presenting television, or radio broadcast, if the broadcast includes an embedded signal which instructs for the presentation of content data, the content data may he output (not shown). Another alternative is to perform such a process that suitable content data can be output according to the contents of the television broadcast or the radio broadcast. The contents of the television broadcast or the radio broadcast may be obtained from an EPG (Electronic Program Guide) or from attribute data embedded in the broadcast.

Throughout the rest of the document, die term “channel switching” refers not only to complete switching between channels, but also to switching to the display of content data and other data (e.g., television broadcast) by dividing the screen, the display of either of the data in an inset, or a superimposition display. For example, if the content data is a still image which has been subjected to a process that renders an image appear transparent, that is, if the image appears to have a hole in part of the image, the superimposition display can have such an effect that the data which is not the content data appears surrounded by the content data.

The part of the operation from the content data processing up to the automatic output of the content data (i.e., S3) will be described in reference to FIG. 6, The flow chart in FIG. 6 is a subroutine of S3.

First, the data processing section 2 decompresses the content data received from the IrDA receiving section 13 into, for example, a display image received in a JPEG file (S11). The decompression enables the data compressed in the transmitter end, such as a mobile phone, to be displayed on a wide-screen television. Needless to say, the content data is not compressed, it does not have to be decompressed.

Next, the data processing section 2 checks the size of the display image obtained from the decompression (S12). The size here is not the amount of data, but a size with respect to the screen on the output section 9. In other words, the section 2 checks if the display image after the decompression is large or small relative to the screen.

If the display image is either larger or smaller than the screen of the output section 9, the data processing section 2 processes the display image so that it fits the screen of the output section 9 (resizing; S13). This particular resizing is however not always necessary. The display image may be resized according to the user's own settings.

The data processing section 2 writes the resized display image to a VRAM, memory, or other display buffer (S14). When a display buffer is assigned for each channel, the display image is written into the display buffer assigned for the image channel. When a display buffer is not assigned for each channel, the display image is temporarily stored.

Next, the data processing section 2 sends the content data received from the IrDA receiving section or the decompressed or otherwise processed content data (display image) to the list appending section 3. The list appending section 3 appends the content data received from the data processing section 2 to the content data list 15 (stores the data in the data storage section 4; S15; FIG. 7).

Thereafter, the list appending section 3 sends the same data as the content data appended to the content data list 15 to the second input switching section 14, Upon receiving the content data from the list appending section 3, the second input switching section 14 switches the input source to the image channel (the channel for content data display) (S16).

Next, referring to FIG. 7, a process will be described in which the list appending section 3 appends the content data received from the data processing section 2 to the content data list (S15). FIG. 7 shows a subroutine of S15, AP is an appendance pointer pointing to the place where new content data is to be appended. DP is a display pointer pointing to the content data to be displayed in the content data list. NC is the number of sets of content data on the content data list 15.

The list appending section 3 determines whether the number, NC, of sets of content data is 0, that is, whether the content data list 15 is empty (the data storage section 4 holds no content data) (S17). If the number; NC, of sets of content data is 0 (YES in S17), the list appending section 3 initialises the appendance pointer AP. The appendance pointer AP is initialised to 1 if the content data list is an array beginning with 1 (S18). Needless to say, if the content data list 15 is an array beginning with 0, the appendance pointer AP is initialised to 0.

After the initialization of the appendance pointer AP or if the number, NC, of sets of content data is not 0 (NO in S17), the list appending section 3 stores the content data to a place indicated by the appendance pointer, that is, the data storage section 4 indicated by the AP-th on the content data list (S19).

If there is provided another data storage section 4 external to the data output device, the content data received may be stored in the data storage section 30 external to the data output device, and the list appending section 3 may store in the content data list 15 the place where the content data is stored.

Thereafter, the list appending section 3 changes the display pointer DP so that it is equal to the appendance pointer AP (S20). In other words, the display pointer DP is set to point to the content data list 15 in which the new content data has been stored. The list appending section 3 increments the appendance pointer AP by 1 to prepare itself for reception of a next set of content data (S20). At the same time, the section 3 increments the number, NC, of sets of content data by 1 (S20).

The processing described above stores sets of content data in the order of reception. The description is not limiting. For example, if new content data is to be stored right next to the content data displayed recently, the appendance pointer AP and the display pointer DP are rendered equal to current display pointer+1.

Next, the above-mentioned designated content data display processing will be described in reference to FIG. 8.

FIG. 8 is a subroutine of S6, This content data display processing is carried out by the content data display processing section 6.

As in FIG. 7, DP is the display pointer for the content data list, and NC is the number of sets of content data on the content data list 15, For convenience in description, the content data list 15 is assumed to sort (classify) content data by the order of reception. By this sorting, the content data received earliest comes to the “head” of the content data list 15, and the content data received last comes to the end of the content data list 15. The content data, list 15 may sort data by name or by other rules.

First, it is checked whether the content data list 15 is not empty, that is, whether the number, NC, of sets of content data is not 0 (S21). If the content data is empty (YES in S21), an error message, “There is no content,” is displayed on the output section 9 (S31), thereby terminating the processing. The display may be switched to the Image channel only while the error message is being displayed and then switched back to the previous channel when the message display terminates. Alternatively, the message may be superimposed on another channel display. A further alternative example is to display only the error message on a blue or black background or a landscape picture as soon as the display is switched to the image channel.

If the number, NC, of sets of content data is not 0 (NO in S21), it is determined whether the way content data is designated is UP (previous), DOWN (next), or CURRENT (S22).

“UP” is the designation of the content data received immediately before the image channel being displayed. If the way content data is designated is “UP,” the display pointer DP is decremented by 1 (S23), Next, it is determined whether the display pointer DP points to the head of the content data list 15 (S24). If the display pointer DP points to the head of the content data list 15 (YES in S24),the display pointer DP is rendered to point to the end of the content data list 15 (S25). After S25 or if NO in S24, the DP-th on the content data list 15 is written to the display buffer (329).

“DOWN” is the designation of the content data received immediately after the image channel being displayed. If the way content data is designated is “DOWN,” the display pointer is incremented by 1 (S26), Next, it is determined whether the display pointer DP points to the end of the content data list 15 (S27). If the display pointer DP points to the end of the content data list 15 (YES in S27), the display pointer is rendered to point to the front of the content data list 15 (S28). After S28′or if NO in S27, the DP-th on the content data list 15 is written, to the display buffer (S29). If the way content data is designated is CURRET in S22, the DP-th on the content data list 13 is written to the display buffer (S29). If there is provided no image channel display buffer in S29, the image of the content data is temporarily stored.

Thereafter, the input source is switched to the image channel (content data) (S30), thereby terminating the operation.

Next, the input switching will be described in reference to FIG. 9. FIG. 9 is a subroutine of S7. The input switching is carried out by the first input switching section 7.

First, the first input switching section 7 determines whether or not an input switching command, is entered by pressing UP/DOWN on the channel buttons (referring to both the image channel button 24 and the television channel button'28) (S41).

If the command is entered by pressing UP/DOWN on the channel buttons, the channel list is made UP/DOWN (S42, S43). The channel number may be incremented if UP is pressed, or vice versa.

Next, it is determined whether the channel selected as a result of UP/DOWN is an image channel (whether the input source is content data) (S44). If it is an image channel (YES in S44), the designated content data=CURRENT, and the operation proceeds to the content data, display processing shown in FIG. 8.

If the input switching command is not UP/DOWN S41, that is, if an input source is directly designated, the designated source type is determined (S45).

If the input source is the image channel as a result of the determination, designated content data=CURRENT, and the operation proceeds to the content data display processing shown in FIG. 8.

If the input source is a television channel (for example, channel x) in S45, the input source is switched to the designated channel (S46). If the input source is another source (for example, video) in S45, the input source is switched to the designated source (S48).

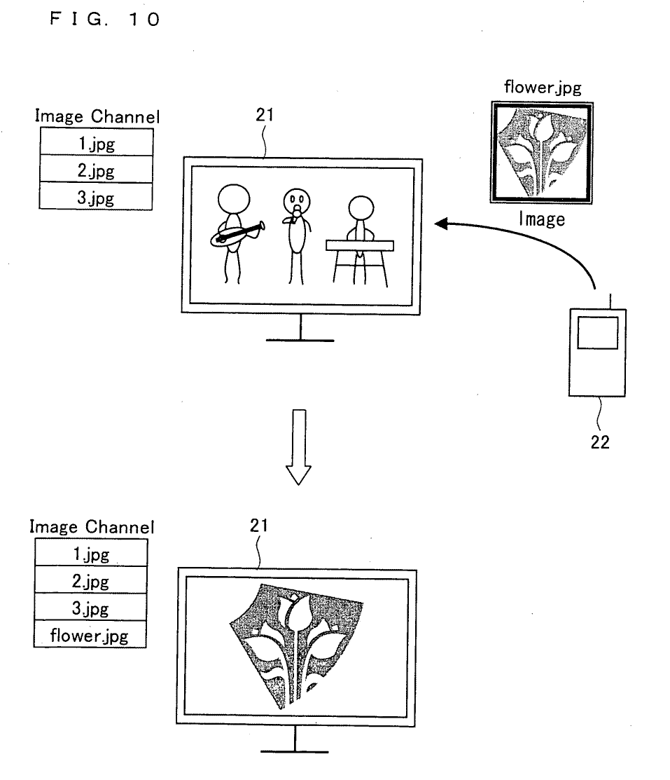

Owing to these settings, if an image “Flower.jpg” is transmitted by an infrared beam from a mobile phone 22, for example, while the user is viewing, for example, a music program (any program on a non-image channel) on a television 21, the screen of the television 21 automatically (the user does not have to do any operation on the television) switches to the image Flower.jpg as shown in FIG. 10. Further, the image Flower.jpg is stored in an image channel, provided on the content data list 15 simultaneously with the switching; the image can be viewed again at any time.

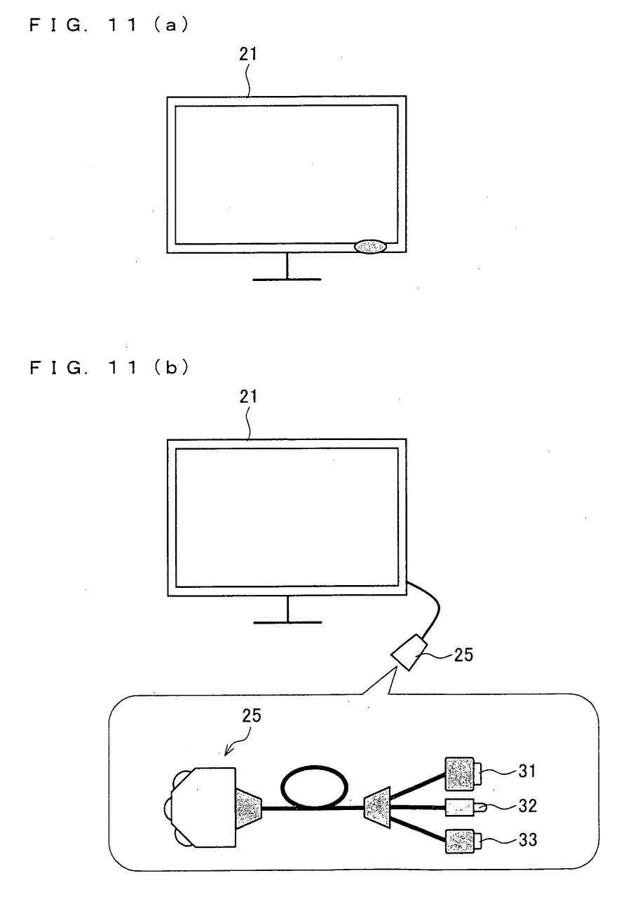

FIG. 11 is an illustration of the television 21 containing the data output device of the present embodiment. FIG. 11(a) shows the receiving section 1 and other data output devices being provided in the main body of the television 21. Alternatively, as shown in FIG. 11(b), the data output device may be the adapter 23 (see FIG. 1) so that the device can be plugged into and pulled out from the television 21. These settings enables the use of a conventional television. Note that if the adapter 25 is provided separately from the television 21 as shown in FIG. 11(b), the adapter 25 is preferably provided with a means that receives a remote controller signal (remote controller signal receiving section). Alternatively, if the data storage section 4 resides inside the adapter, and the television 21 can receive a control signal, the adapter may receive those signals by which the content is manipulated.

FIG. 1 shows the adapter 25 containing the IrDA receiving section 13, the data processing section 2, the list appending section 3, the data storage section 4, the content data display processing section 6, and the second input switching section 14. There are other possible configurations, The second input switching section 14 may be provided to the television.

The adapter 25 has a D terminal/HDMI31, a composite video terminal/audio terminal 32, and a S terminal 33 as shown in FIG. 11(b) so that the adapter 25 can be freely plugged into and pulled out from the television 21.

Similarly to the adapter 25, a DVD recorder or a HDD recorder may be used that are configured so that the recorder can be plugged into and pulled out from the television 21 or is capable of wireless or network connection.

As shown in FIG. 12, the status of the data output device may be determined between S2 and S3 in FIG. 5 to carry out a process in accordance with the status of the data output device (S51). In other words, a status detection processing section (status detection processing means (not shown)) which detects the status of the data output device and carries out a process in accordance with the status of the data output device may be provided between the IrDA receiving section 13 and the data processing section 2 in the data output device shown in FIG. 1.

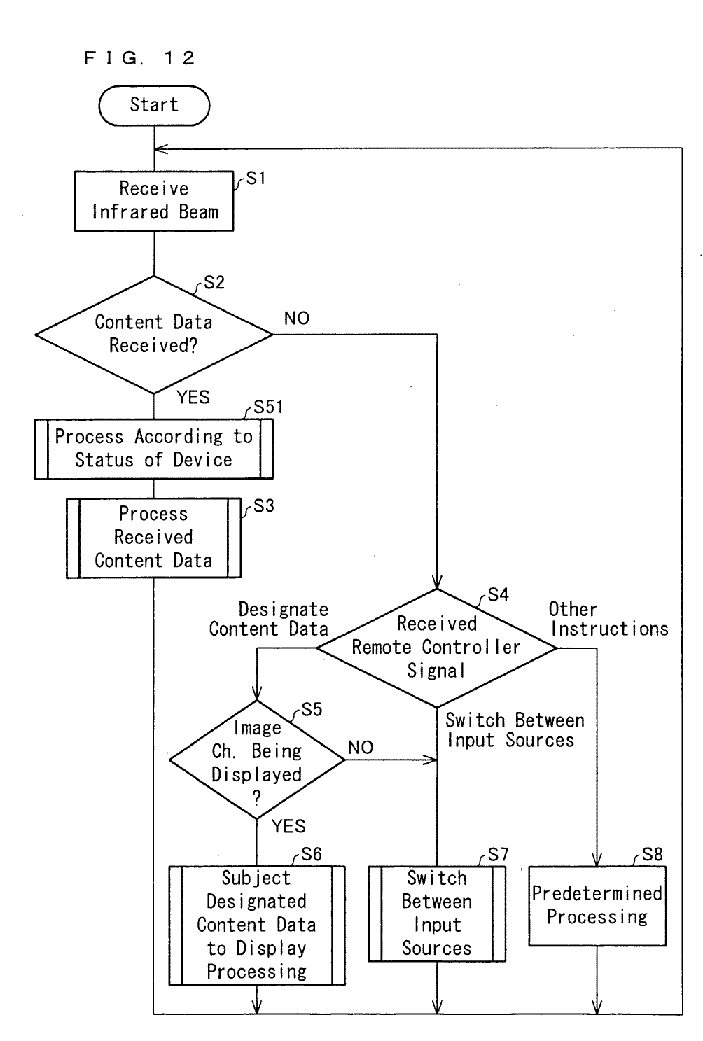

In other words, if received signal is an IrDA signal (YES in S2), the status of the data output device is determined first and carries out a process in accordance with the device status (S51). Thereafter, the content data processing is performed (S3). Next, S51 will be described more specifically in reference to the flow chart shown in FIG. 13.

First, the status detection processing section confirms whether power supply to the output section 9 is turned on (S52). In other words, the status detection processing section confirms whether the device is ready to output images or sound. If the power supply to the output section 9 is not turned on (NO in S52), the status detection processing section turns on the power supply to the output section 9.

For example, if power supply to the device main body is turned on, and the power supply to the output section 9 is not turned on, no image can be displayed. Similarly, if power supply to speakers or an amplifier is not turned on, the user hears no sound or very small sound. The status detection processing section may confirm whether the device main body is powered on (standing by), and if so, render it operable (turn it from standby to a state where it can output content and other data).

After turning on the power supply to the output section 9 or if the power supply to the output section has been turned on (YES in SS2), the status detection processing section determines the type of the channel cc currently being displayed (SS4).

If the channel cc currently being displayed is a video, the status detection processing section determines whether a video is being reproduced (S57). If no video is being reproduced (NO in S57), the status detection processing section terminates the process.

On the other hand, if a video is being reproduced (YES in 557), the status detection processing section stores a play position PP (for example, the Lime from the beginning of the video) (S58). The status detection processing section then stops or pauses the reproduction (S59). If the video was being reproduced at double the speed, the status detection processing section may also store that status. Next, the status detection processing section puts up a video discontinuation flag (turn on a flag; S60) to memorize that the video viewing was paused; thereby terminating the process. For a video being reproduced on a HDD recorder or a DVD recorder, the status detection processing section preferably stores the title, etc. of the video being reproduced to identify it. In addition, the status detection processing section may store the address of the video.

If the channel cc currently being displayed is a television program, the status detection processing section starts recording the program (S55), The status detection processing section puts up a background recording flag (S56) to memorize that the program is being recorded while displaying from another source, thereby terminating the process. The recording may be terminated when the program ends or continue until the first commercial is over. It may also terminated at an instruction from the user, The channel cc currently being displayed was another channel (for example, a streaming broadcast), the status detection processing section memorizes a reproduction point and the URL of the streaming server (not shown) before terminating the process.

In this embodiment, the content data output device and the video device may be provided as separate devices or as a single device. If the content data output device and the video device are provided, as separate devices, they can be controlled by, for example, the following two methods.

The content data output device and the video device are connected either via a wire or wirelessly using the DLNA (Digital Living Network Alliance) technology to transmit/receive, control commands.

AV data is transmitted/received between the devices by a method capable simply of transferring AV signals (e.g., via wire, such as a composite cable or a D terminal, or wirelessly by IEEE 302.11). The content data output device and the video device are placed relatively closely so that the devices can listen to each other for control commands.

The status detection processing section does not have to detect the status of the content data output device; it may detect an instruction from the user. For example, when the user transmits content data, the user may send a command to “display the data later.” In a case like this, step S16 of switching the input source to an image channel may be skipped in the processing, of the received content data depicted in FIG. 6. Details will be given later,

As another example, the data (television broadcast, radio broadcast, Internet content, etc.) being displayed when the user transmits the content data contains information that prohibits interruption, a process by which to display the content data later may be carried out.

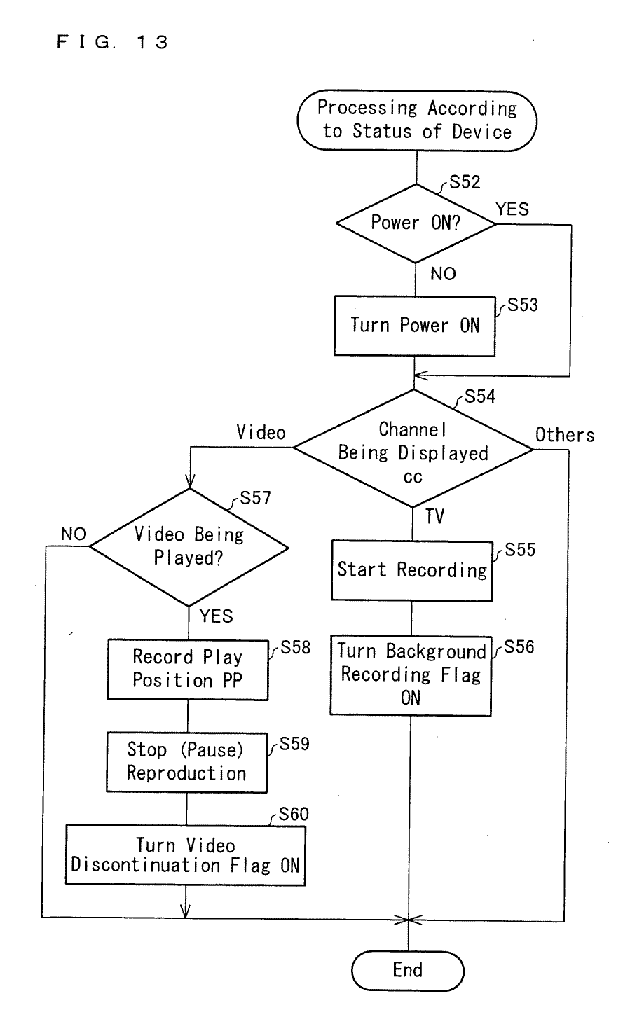

The input switching depicted above in reference to FIG. 9 may be implemented as in the flow chart FIG. 14. The description will be limited only to differences from the process shown in FIG. 9.

S61 and S62 detailed below may be provided between S41 and S45 shown in FIG. 9. If the input switching command is neither UP nor DOWN in S41, it is determined whether the input switching command is entered through the GO BACK button 27 (see FIG. 4) (S61), If not, (NO in S61), the operation proceeds to S45, On the other hand, if the input switching command is entered through the GO BACK button 27 (YES in S61), the input switching destination is set to cc (S62), and the operation proceeds to S45.

In addition, following S45 to S48, the “channel cc currently being displayed (video, image channel, or television channel)” after switching is stored as a means to handle an input through the GO BACK button 27. If it is a television channel, it would be better to record also which of television channels was being displayed.

A channel changing history may be recorded like a stack: when the channel is switched back once, the channel at the top of the stack (the immediately previous channel) is removed from the history stack and the reference pointer of the stack is reverted by one. This management of history by means of a stack enables the user to use the GO BACK command intuitively as on a browser.

Next, a process will be described in reference to FIG. 15, which, in response to the pressing of the GO BACK button 27, allows the user to again view the previous program or video starting at where he left off after a process is carried out in accordance with a status of the device (for example, television channel recording may be started or video reproduction may be stopped) as in FIG. 13 upon receipt of the content data. Specifically, different processes will implemented depending on the input source to which the channel will be switched.

The process in FIG. 15 may be carried out in response to a direct input source switching command, not necessarily by means of the GO BACK button 27.

No explicit command input from the user is essential either. The display period for the content data may be limited to, for example, 15 seconds, after which period the GO BACK process is carried out. Furthermore, if the content data is those types of multimedia data, such as movie and music data, which has a fixed duration, the GO BACK process may be carried out after that duration (after the reproduction ends).

First, it is determined to which input source the channel should be switched back upon the pressing of the GO BACK button 27 (S71). If the channel should be switched back to a video on the pressing of the GO BACK button 27, it is first checked whether a video discontinuation Hag has been put up (S72). If there is a video discontinuation flag (ON in S72), it is determined that the content data was viewed while viewing a video, and the video is reproduced starting at the stop position PP (S73). After S73 or if OFF in S72, the input source is switched to the video (S74), and the video discontinuation flag is reset (S75), thereby terminating the process.

If the channel should be switched back to a television channel upon the pressing of the GO BACK button 27, it is first checked whether a background recording flag has been put up (S76). If there is a background recording flag (ON in S76), it is determined that the content data was viewed while watching television, and a message, such as “Want to resume watching television?;” is presented to the user to accept a user command as to whether to resume watching television (S77).

If a command for resuming watching television is received from the user (or automatically) (YES in S77), the input source is switched to the recorded television program (i.e., video) (S79) so that the user can resume watching television starting at where he left off to view the content data (for example, from the beginning of the recording) (S80).

If there is no background recording flag (OFF in S76) or there has been provided a background recording flag without a command for resuming watching (NO in S77), the input source is switched to a normally instructed channel (S78). After S78 or S80, the background recording flag is reset (S81), thereby terminating the process.

If an image channel has been specified or any other source has been selected in S71, the same processing as above is carried out; no further description is given.

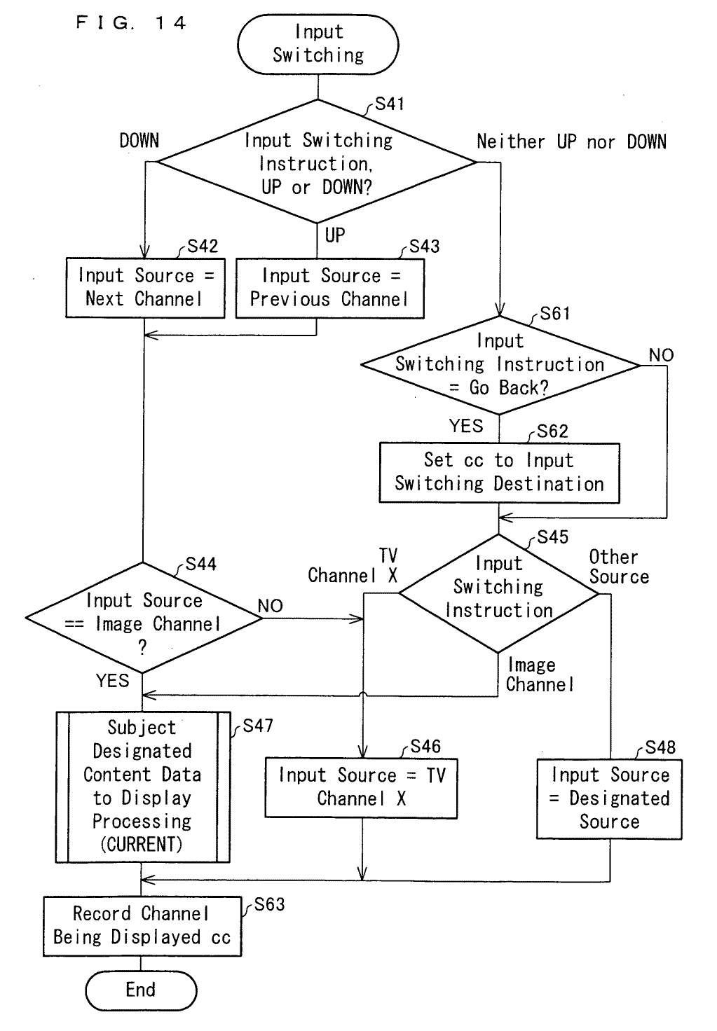

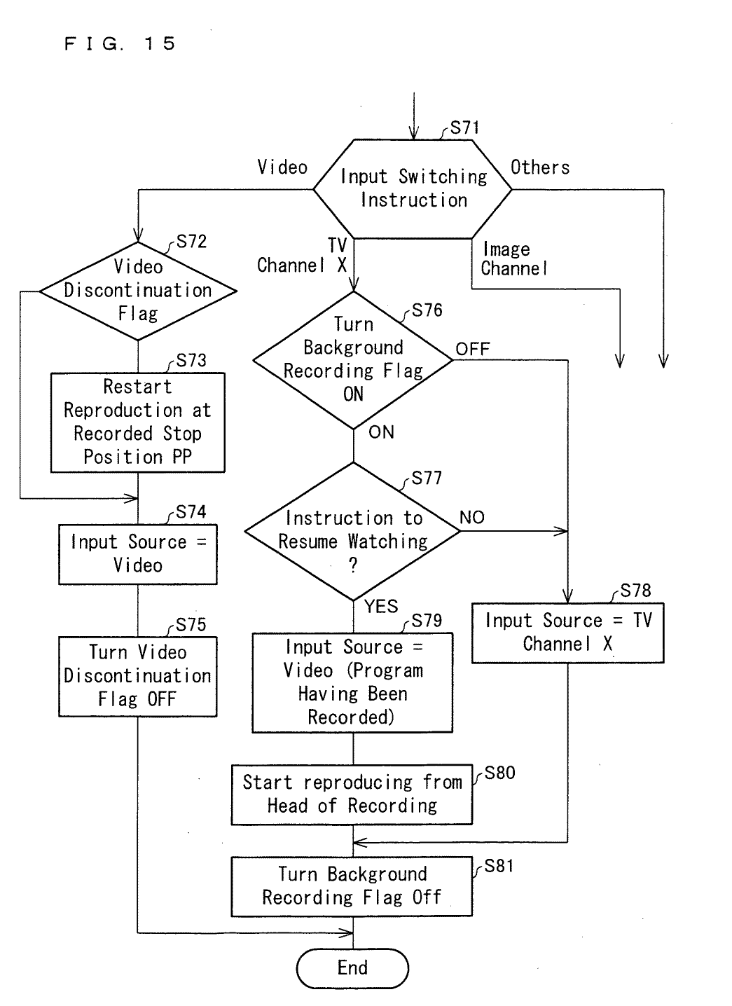

Next, FIGS. 16(a) to (c) are illustrations of a slide show, as an example, on an image channel. When the data output device receives a command for a slide show, the content data stored in the data storage section 4 is sequentially output (displayed) at a particular time interval (for example, 5 seconds) starting with the set of content data received last as shown in FIG. 16(a), in which A is the first content data received, and J is the last content data received. After displaying A, J may be displayed to display the content data sequentially once again or the slide show may be paused to display any one of the content data. Alternatively, the channel may be switched to the one being displayed before the slide show reproduction by the aforementioned GO BACK process.

Now, the following will describe a case where a PREVIOUS (REWORD) command is entered while displaying C as shown in FIG. 16(b). When the user enters the PREVIOUS command while C is being displayed, the immediately previous set, D, of content data is displayed. Thereafter, after a particular period, C, B, and A are displayed in this order. When the PREVIOUS command is entered, the content data may be displayed at an interval little longer than the particular time interval for the slide show (for example, 8 seconds). On the other hand, when the user enters a NEXT (FORWARD) command, needless to say, the display may be switched to a next set of content data before the particular time interval is reached.

Next, a case will be described in which a PAUSE command is entered while, for example, displaying E as shown in FIG. 16(c). When the user enters the PAUSE command while E is being displayed, E is continuously being displayed; no switching to D occurs. After the PAUSE command is received, if a command for slide show resumption is received, the display is switched to the original mode of displaying the content data at the particular time interval in the order of D, C, and so on.

The slide show reproduction may be triggered by reception of the content data. Alternatively, the reproduction may be started effectively upon switching to the image channel either directly or in response to reception of a channel UP/DOWN command for channel switching.

If the content data is moving images, the moving images may be reproduced sequentially, each only for a predetermined duration from the beginning as in the above case. If the moving image is in a format that allows the designation of a major portion (for example, a highlight), the major portion may be reproduced alone or together with a predetermined length of the preceding portion and the succeeding portion. Alternatively, each moving image may be reproduced from, the beginning to the end before proceeding to a next moving image.

If new moving image content data is received while the moving images (content data) are still, being sequentially reproduced by the slide show (that is, the reproduction of the old moving images has not ended yet), the new images may be only received first so that it can be later reproduced after the old moving images content data is all reproduced. The same procedures are also applicable when the content data is still images: only the reception is done first if the predetermined reproduction time has not elapsed.

The same procedures, needless to say, are also applicable to sound and other various kinds of multimedia data, as well as moving images and still images.

There may be provided a plurality of content data lists 15. The content data (or information on where the content data is stored) may be divided into a plurality of groups using the plurality of content data lists 15 before being stored. This management of the content data lists 15 enables the user to present the content data lists 15 or the groups in a familiar way as “albums,” especially, when the content is photographs.

Grouping (classification) may be done as the user wishes (“Photographs on School Excursion,” “Photographs on Family Trip,” “Photographs on School Play,” etc.) or by the attribute data (place, date and time, author, etc.) of each set of content data. Many recent digital cameras, etc. are capable of recording attribute data related to each photograph (camera model, date and time, exposure, etc.) as Exif data. The grouping may be done based on the Exif data.

If the content data is music files, especially, in the MP3 format, ID3 tags assigned to MP3 files may be used for the grouping. Other attribute data specified for a data format, if any, may be also used for similar grouping.

FIGS. 17(a) to (c) illustrate an example of display Images for a list of groups and a list (thumbnails) of content found in one group when there are more than one content data list 15 or the content data is classified into groups for storage.

FIG. 17(a) is a display example for a group list (album list). Representative content and its description are shown for each group. The user can select the group he wants to see on the screen. He can select on a remote controller, a touch pad, or a touch panel or by pointing using a mouse. These methods are well known; detailed description is omitted. When one of the groups is selected, the content classified to the selected group is displayed in a list.

If the content is grouped as above, the group last viewed (selected) may be recorded so that it can be determined which of the groups is designated in a command before step S22 in which it is determined which content data is designated in the display processing for the designated content data shown in FIG. 8. In that extra step, for example, in the absence of a specific instruction, (for example, if the aforementioned group list has been presented and the user has selected a group), the group last viewed is determined to be the “designated group.”

FIG. 17(b) is an example of a displayed, list of contents. Typically, the contents are displayed as “thumbnails.” FIG. 17(c) shows a newly received set of content being added to the content data list so it appears before the set of content F when the new set is received after the set of content F has been selected as in FIG. 17(b). The thumbnail images may be created by resizing each set of content or the thumbnail data contained in the Exif information may be used.

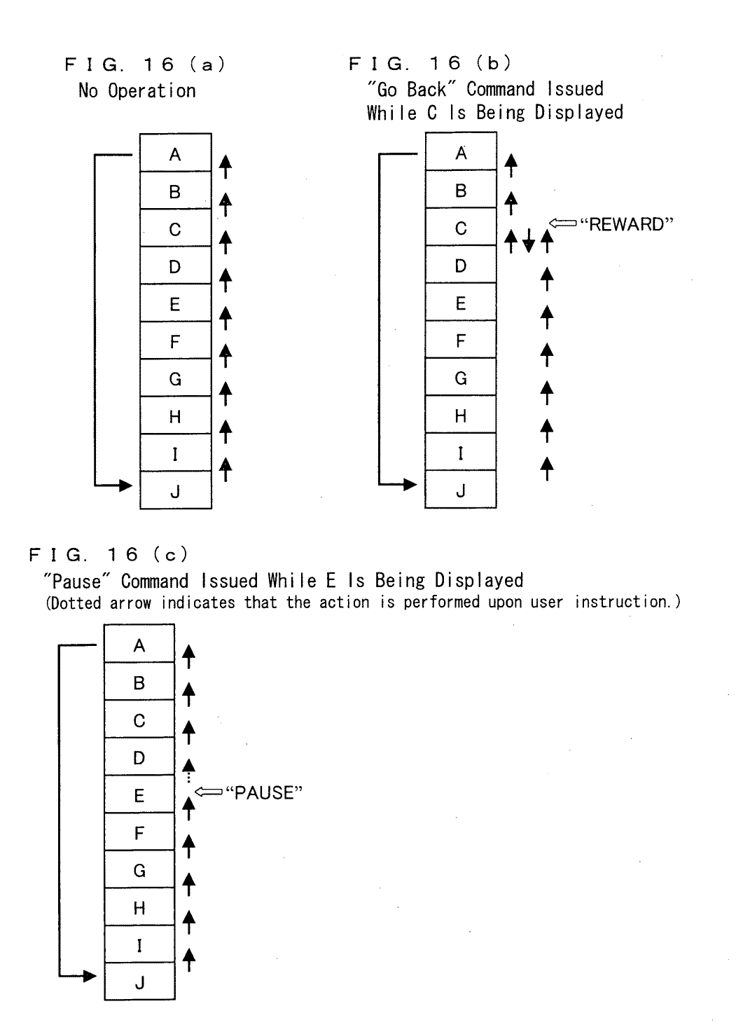

FIG. 18 is an illustration of a display screen of a transmitter (mobile phone, PDA, digital camera, etc.) which transmits the content data. The figure shows a display screen when a plurality of sets of content data (A, B, C, D) are to be transmitted to the data output device. First, the user selects the sets of content data to be transmitted and enters a command for transmission to sequentially transmit the sets of content data. If the receiver has a sufficiently high processing capability, the sets of content data may be transmitted in a single transmission.

The transmission screen shown in FIG. 18 may be prepared in advance in the transmitter or obtained separately from the receiver (content presentation device or data output device) by wireless or wired communications. By obtaining the screen from the receiver, it becomes possible to use a transmission screen at all times by which image transmission suitable for conveniences of the receiver (presentation capability, storage capacity, etc.) is readily available. In addition, needless to say, the screen does not need to be direct obtained from the receiver; it may be obtained from an external network. Such an approach is effective if the data storage section 30 resides outside the content presentation device, for example, in a server.

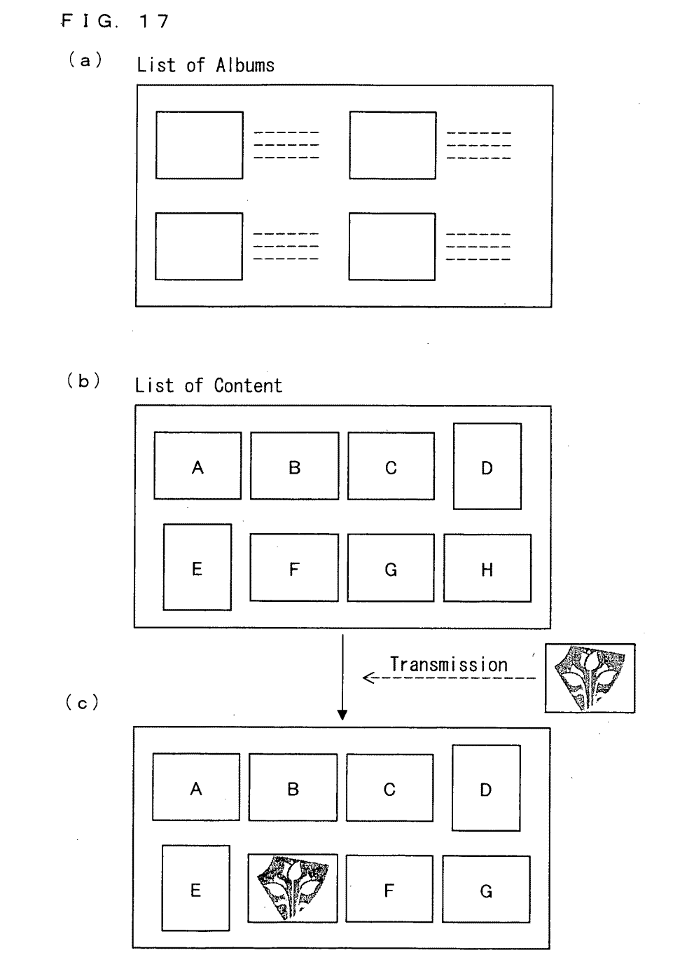

FIGS. 19(a), 19(b) illustrates a screen on the output section 9 when the transmitter has sent a plurality of sets of content data in a single transmission. In cases like this, whether or not the plurality of sets of content data has been sent in a single transmission is determined from, for example, whether or not the plurality of sets of content data has been received in a single session (from the receipt of a session starting packet to the reception of a disconnection packet.

Other examples of determining whether or not the plurality of sets of content data has been sent in a single transmission are to transmit the last part of the content data together with data indicating an end of transmission from the transmitter or to translate a predetermined blank period (for example, 15 seconds) after the completion of reception of a previous set of content data as indicating more than one set having been transmitting in a single transmission.

FIG. 19(a) is an example of a screen on the output section 9 showing a simultaneous display of the plurality of sets of content data sent from the transmitter.

The sets of content data are sequentially displayed in the order of reception. If a photograph (content data) A is received first, the photograph A is displayed across the screen.

Thereafter, if a photograph B is received, the screen is filled with the photograph A and the photograph B. Similarly, a photograph C and a photograph D are individually added to the display when they are received. Landscape content data may be received in some cases; this display in FIG. 19(a) is a mere example.

FIG. 19(b) is an example of a sequential display of the received content data. The data output device further includes a timer and displays the received sets of content data (A, B, C, D) at particular time intervals (for example, 5 seconds). If the receiver has a high processing capability, the receiver can receive all the sets of content data, while displaying. If the processing capability is not sufficient for the reception of all the sets of data, the receiver may, when It is readily for reception of a next set of content data, inform the transmitter that it has completely received and stored the previous set of content data and send a request for transmission of a next set of content data.

If the content data is a photograph with Exif data, the receiver first receives the thumbnail in the Exif and displays it until it receives the complete photograph and becomes readily to display the complete one. The user does not have to wait for long.

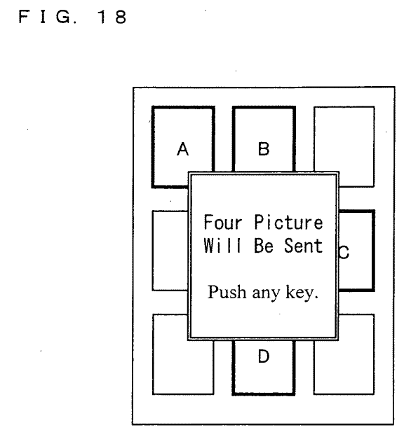

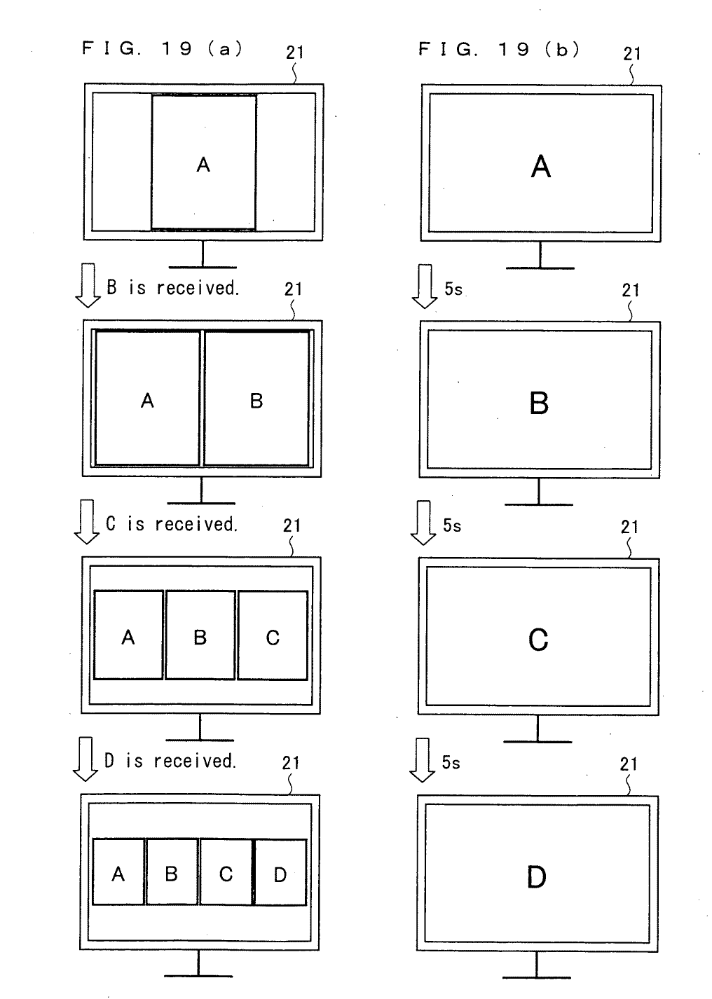

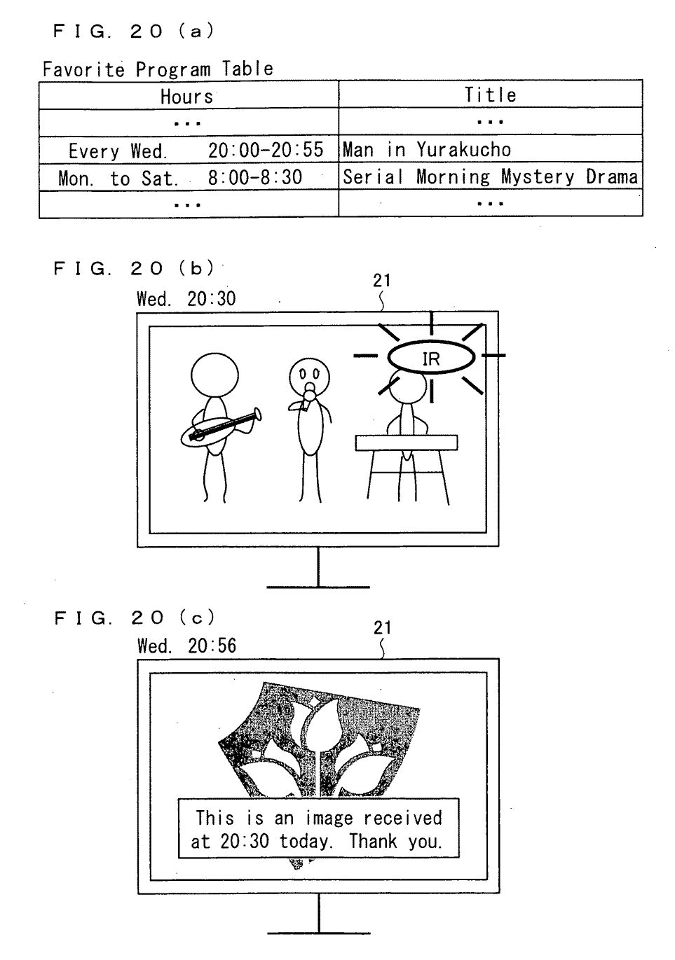

Next will be described, in reference to FIGS. 20(a) to 20(c), cases where the received content data is not immediately displayed. Such a display is realised by, for example, skipping step S16 in which the input source is switched in the received content data processing shown in FIG. 6.

For example, favorite programs (designated television programs) are registered in a favorite program table (designated program storage section) like the one in FIG. 20(a). The second input switching section 14, upon reception of the content data, refers to the favorite program table to check whether there is a registered favorite program at the time when the content data is received. If there is, the section 14 does not, instruct the output section 9 to output the content data.

As another example, if there is a VOD (Video On Demand) content or the like of which the viewing period is close to expire, the section 14 may similarly not instruct the output section 9 to output the content data to give priority to the viewing of the VOD content. Needless to say, other various priority control methods arc also possible, An example is to give priority to ongoing high image quality recording or to ongoing content data reproduction that requires high processing power.

As another example, it may be determined whether to give priority over the content data, superimpose the content data, or display the content data simultaneously with the data being displayed, depending on the nature of the data being displayed. More specifically, if a still image is being displayed, and audio data has been received, the device may determine that the sets of data can be output in either a parallel or simultaneously manner without any accompanying trouble, since one of the sets of data is visual, and the other is audio. In a case like this, both sets of data can be output with no special priority control. Thus, the user can enjoy the received audio data as the background music of the still image being displayed. Furthermore, by associating the audio data to the still image data, the still image data can be displayed with parallel or simultaneous reproduction of the audio data without retransmitting or retrieving the audio data.

As another example, the display of the content data can be delayed if, for example, the content data received from the transmitter is designated for a later display. As a further example, settings may be made so that the user is asked if he wants to have it displayed immediately.

Nevertheless, the user should be notified of a complete reception of the content data. Therefore, it is preferable if, for example, an “IR” logo flashes for couple of seconds on the screen of the output section 9 as shown in FIG. 20(b), to notify the user of the complete reception of the content data.

If the television 21, the adapter 25, etc. have an LED, a liquid crystal screen, an organic EL screen, or a like auxiliary output section provided separately apart from the output section 9, that auxiliary output section may be used to notify of the completion of receipt. The provision of the auxiliary output sector prevents to some extent interruption of the ongoing display of the content on the output section 9. The received content data is presented to the user either in response to an user command or automatically.

In FIGS. 20(a) to 20(c), the content data is being displayed after the broadcasting hours of the favorite programs. To inform the user that the content data was received some time ago, a message “Data was received while the favorite programs were on Thank you” may be displayed together as shown in FIG. 20(c). Furthermore, as shown in FIG. 20(c), to inform of the reception time of the content data, it may be displayed together. If the message disappears after a period (for example, 3 seconds), the user can relax and enjoy the content data.

In FIGS. 20(a) to 20(c), the content data is being displayed after the broadcasting hours of the favorite programs. The content data may be displayed during commercials in the broadcasting hours of a favorite program. When the commercials are over, the favorite program appears again. In addition, in such cases, the reception time of the content data may be displayed. When the commercials are over and the favorite program appears again, a message “Commercials ended” may be displayed. If it is known in advance what time the commercials end, a count down message may be displayed, starting at a few seconds (for example, 5 seconds) before the commercials are over.

The display example in FIG. 20(c) is effective also in cases when the use has designated the content data for a later display as described above. In a case like this, the reception time message is effective when the received content data is displayed for the first time in response to a user command for a display of the content data.

The data output device of the present embodiment can be used with a display device which is capable of displaying two different videos, one for a left-side viewer and another for a right-side viewer. The display device is termed dual view liquid crystal. A parallax barrier is provided before the liquid crystal panel to split light from the backlight to the left and right for each pixel to display different information for the left and the right. Three or more different images can be displayed depending on the positioning of the parallax barrier(s) and other conditions. Different images can be displayed vertically too.

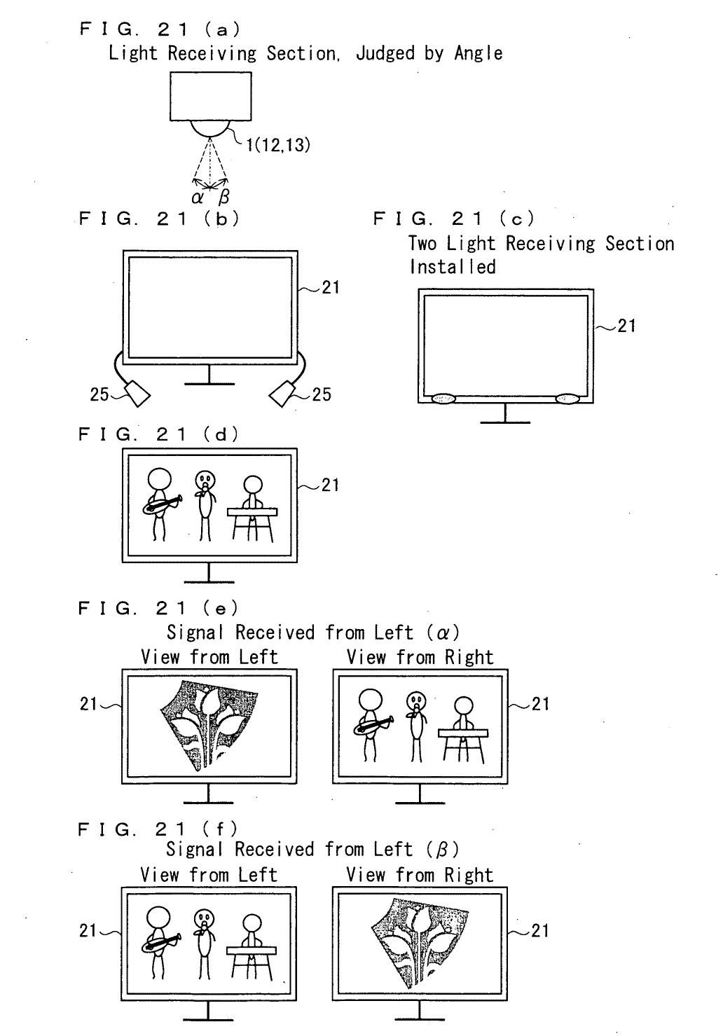

It is preferable if the liquid crystal display device includes (i) a receiving section 1 capable of receiving, while discriminating between, an incoming infrared beam from, the left and another from the right (α, β) as shown in FIG. 21(a), (ii) two adapters capable of receiving, while discriminating between, an incoming infrared beam from the left and another from the right as shown in FIG. 21(b), or (iii) two receiving sections 1 capable of receiving, while discriminating between, an incoming infrared beam from the left and another from the right as shown in FIG. 21(c).

In any of these configurations, upon receiving “flower.Jpg” from the left (α) on an IrDA signal while displaying the music program as shown in FIG. 21(d), the display device displays the flower.Jpg image for the left-side viewer and continues to display the music program for the right-side viewer as shown in FIG. 21(e). On the other hand, upon receiving “flower.Jpg” from the right (β) on an IrDA signal while, displaying the music program as shown in FIG. 21(d), the display device continues to display the music program for the left-side viewer and displays the “flower.Jpg” image for the right-side viewer (β) as shown in FIG. 21(f).

In addition, the data output device of the present embodiment can be used with a double-vision compatible car navigation system. The double vision system operates on the same principles as the dual view liquid crystal.

Generally, drivers are prohibited from viewing AV content while driving for safety reasons. In any of the configurations of FIG. 21(a) to (c), the AV content transmitted from the assistant driver's seat is made invisible to the driver.

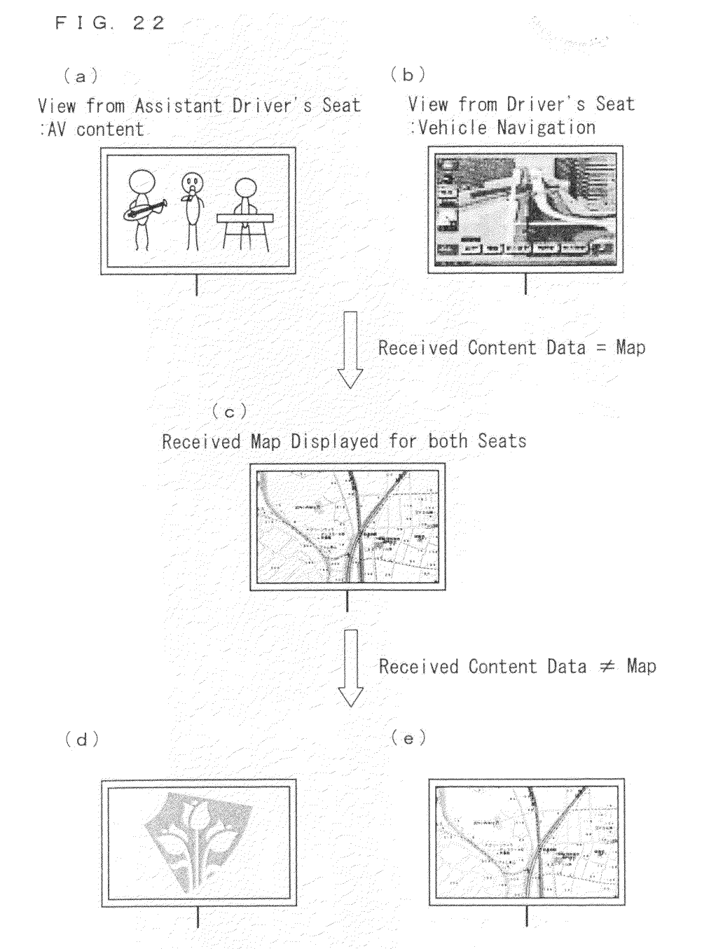

FIG. 22(a) shows an AV content display as viewed from the assistant driver's seat. FIG. 22(b) shows a car navigation display as viewed from the driver's seat. An AV content discrimination section is provided with the data output device (not shown in FIG. 1).

The AV content discrimination section determines whether or not the received content data is the AV content. If the received content data is not AV content (for example, a map), the display shown in FIGS. 22(a), 22(b) switches as shown in FIG. 22(c) so that the same display is displayed for both the driver and the assistant driver.

On the other hand, if the received content data is AV content (for example, “flower.Jpg”), the display switches as shown in FIGS. 22(d), 22(e) so that the image can be viewed only from the assistant driver's seat (it cannot be viewed from the driver's seat).

The present invention is not limited to the description of the embodiments above, but may be altered by a skilled person within the scope of the claims. An embodiment based on a proper combination of technical means disclosed in different embodiments is encompassed in the technical scope of the present invention.

Finally, the blocks of the data output device, especially, the list appending section 3 and the second input switching section 14, may be provided in the form of hardware logic circuits. Alternatively, they may be realized in the form of software executed by a CPU as follows.

The data output device includes a CPU (central processing unit) and memory devices (memory media). The CPU (central processing unit) executes instructions in control programs realising the functions. The memory devices include a ROM (read only memory) which contains programs, a RAM (random access memory) to which the programs are loaded, and a memory containing the programs and various data. The objective of the present invention can also be achieved by mounting to the data output device a computer-readable storage medium containing control program code (executable program, intermediate code program, or source program) for the data output device, which is software realizing the aforementioned functions, in order for the computer (or CPU, MPU) to retrieve and execute the program code contained in the storage medium.

The storage medium may be, for example, a tape, such as a magnetic tape or a cassette tape; a magnetic disk, such as a floppy (Registered Trademark) disk or a hard disk, or an optical disc, such as CD-ROM/MO/MD/DVD/CD-R; a card, such as an IC card (memory card) or an optical card; or a semiconductor memory, such as a mask ROM/EPROM/EEPROM/flash ROM.

The data output device may be arranged to be connectable to a communications network so that the program code may be delivered over the communications network. The communications network is not limited in any particular manner, and may be, for example, the Internet, an intranet, extranet, LAN, ISDN, VAN, CATV communications network, virtual dedicated network (virtual private network), telephone line network, mobile communications network, or satellite communications network. The transfer medium which makes up the communications network is not limited in any particular manner, and may be, for example, a wired line, such as IEEE 1394, USB, electric power line, cable TV line, telephone line, or ADSL; or wireless, such as infrared radiation (IrDA, remote control), Bluetooth (™), 802,11 wireless, HDR, mobile telephone network, satellite line, or terrestrial digital network. The present invention encompasses a computer data signal, on a carrier wave, which is embodied in electronic transmission of the program code.

The content data output device of the present invention preferably further includes status detection processing means which, when the content data is received, either detects a status of the content data output device or receives an instruction from a transmitting end of the content data, in order to perform a predetermined process in accordance with the status detected or the instruction received.

The configuration includes the status detection processing means which, when the content data is received, either detects the status of the content data output device or receives an instruction from a transmitting end of the content data, in order to perform a predetermined process in accordance with the status detected or the instruction received. That removes inconveniences which could happen on the content data output device due to an automatic content data output setup beforehand.

The content data output device of the present invention preferably further includes content data output means for outputting the content data, wherein when the content data is received, the status detection processing means turns on a power supply for the content data output means if the power supply for the content data output means is not turned on.

According to the configuration, the status detection processing means, when the content data is received, turns on the power supply for the content data output means if the power supply for the content data output means is not turned on. Therefore, the content data can be output even if the content data is transmitted when the user has forgot to turn on the power supply for the content data output means.

The content data output device of the present invention is preferably adapted so that the status, detection processing means, when the content data is received, renders the content data output device operable if the content data output device is standing by.

According to the configuration, the content data can be output even if the user transmits the content data when the content data output device is standing by.

The content data output device of the present invention is preferably adapted so that: either the content data output device or a device connected to the content data output device is capable of reproducing a video; and the status detection processing means, if the video is being reproduced when the content data is received, either stops or pauses the reproduction of the video.

According to the configuration, the status detection processing means, if the video is being reproduced when the content data is received, either stops or pauses the reproduction of the video. Therefore, even If the content data is transmitted while the video is being reproduced, the user can later watch the video starting at where he left off.

The content data output device of the present invention is preferably adapted so that the status detection processing means, when the output of the content data ends, releases the video from the stop or the pause.

According to the configuration, the status detection processing means, when the output of the content data ends, releases the video from the stop or the pause. Therefore, even if the content data is transmitted while the video is being reproduced, the user can later watch the video starting at where he left off.

The content data output device of the present invention is preferably adapted so that: the content data output device is capable of outputting television broadcast; and the status detection processing means, if the content data output device is outputting television broadcast when the content data is received, starts recording the television broadcast. According to the configuration, the user can later watch the television broadcast that is disrupted by the preferentially output of the content data.

The content data output device of the present invention is preferably adapted so that the status detection processing means, when the output of the content data ends, starts reproducing the television recording. According to the configuration, if the content data is received during television broadcast output, the recording of the television broadcast starts. When the output of the content data ends, the reproduction of the television recording starts. Therefore, the user can enjoy watching the television program being broadcast while viewing the content data, without missing any parts of the program.

The content data output device of the present invention preferably further includes designated program storage means for storing broadcasting hours of a designated television program, wherein if a television program stored in the designated program storage means is being output when the content data receiving means receives the content data, the content data control means stores the received content data to the content data storage means, but does not output the content data.

According to the configuration, if the user has wrong content data have been transmitted during the designated program stored in the designated program storage means, the user can prevent the output of the content data. Therefore, the disruption of the viewing of the pre-designated program can be prevented.

The content data output device of the present invention preferably further includes content data storage means for storing the content data received by the content data receiving means, wherein after the broadcasting hours of the designated television program, the content data that is stored in the content data storage means, but yet to be output, starts to be output.

According to the configuration, after the broadcasting hours of the designated television program, the content data that is stored in the content data storage means, but yet to be output, is output. Therefore, the user does not miss the content data transmitted during the designated program.

The content data output device of the present invention preferably further includes content data storage means for storing the content data received by the content data receiving means, wherein the content data control means sequentially outputs the content data stored in the content data storage means rat a time interval.

According to the configuration, the content data stored in the content data storage means can be sequentially outputs at a time interval. Therefore, when there are a plurality of sets of content data, all the content data can be viewed without having to switch between external content data.

The content data output device of the present invention is preferably adapted so that the content data control means, if the content data receiving means have collectively received a plurality of sets of content data, outputs the received plurality of sets of content data either partially or entirely in a single screen.

According to the configuration, the collectively received plurality of sets of content data are viewable simultaneously. This is suitable, for example, when the content data is viewed on a wide-screen television.

The content data output device of the present invention is preferably adapted so that the content data control means, if the content data receiving means has collectively received a plurality of the content data, sequentially outputs the received plurality of the content data at a time interval.

According to the configuration, if a plurality of sets of content data has been collectively received, the received plurality of sets of content data can be sequentially outputs at a time interval. Therefore, the user can view without externally manipulating each set of content data. In addition, to view one set of content data at a time, for example, when the content data is viewed on a wide screen, one set of content data is viewable using the entire screen.

The content data output device of the present invention preferably further includes content data storage means for storing the content data received by the content data receiving means, wherein the content data control means includes content data erasing means for erasing the content data stored in the content data storage means according to a predetermined set of conditions.

According to the configuration, although the data storage means has a limited capacity, it can always have storage space be reserved for newly stored content data by suitably erasing data by the content data erasing means. Examples of the predetermined set of conditions are as follows; (i) erase a period after reception; (ii) erase the oldest content data when the total data size of the content data stored (sum of individual file sizes) exceeds a predetermined value; and (iii) erase the least frequently accessed content data when the total data size of the content data stored (sum of individual file sizes) exceeds a predetermined value.

The content data output device of the present invention is preferably adapted so that: the content data output device is capable of outputting television broadcast; and a list of channels for the television broadcast contains a list for the content data so that the content data is selectable by switching between the channels for the television broadcast.

According to the configuration, the channel list for the television broadcast contains a list for the content data so that the content data is selectable by switching between the channels for the television broadcast. Therefore, the television broadcast channels can be changed, and the stored content data channels can be changed too, through a conventional act of zapping television broadcast channels.

The content data output device of the present invention is preferably adapted so that: a set of content data is designated from the list for the content data; and the designated set of content data is selectable.

According to the configuration, the user can select a set of content data by switching to a different channel from the television channels. Therefore, when there are many sets of content data, quick switching is possible

The content data output device of the present invention is preferably adapted so that: the content data receiving means discriminates between directions from which sets of content data have been transmitted; and the content data output means is capable of displaying each set of content data in a different direction so that each set of content data is not displayed in an opposite direction to a direction from which that set of content data has been transmitted.

According to the configuration, the content data receiving means discriminates between directions from which sets of content data have been transmitted. The content data output means is capable of displaying each set of content data in a different direction so that each set of content data is not displayed in an opposite direction to a direction from which that set of content data has been transmitted. Therefore, different sets of data are viewable from different directions, Each set of content data can be displayed for only the viewer who wants to view it (the viewer who is positioned in the direction from which the set of content data has been transmitted).

The content data output device of the present invention is preferably adapted so that: the content data receiving means discriminates between directions from which sets of content data have been transmitted; and the content data output means is capable of displaying each set of content data in a different direction so that any set of received content data is viewable from any direction.

According to the configuration, different sets of data are viewable from different directions. Any set of content data, in whichever direction the set of content data has been transmitted, is viewable from any direction.

In addition, the television of the present invention preferably includes any one of the content data output devices above. According to the configuration, the television obtained includes one of the content data output devices above. The content data becomes easily viewable on a television. The television has the same effects as those described above.

The content data output program of the present invention is preferably a content data output program for controlling the content data output device, enabling a computer to function as the content data receiving means and the content data control means.

The content data output device of the present invention is preferably adapted so that the content data storage means contains a content data list by which the stored content data is managed.

According to the configuration, the content data stored in the content data storage means is managed by a list as a content data list. Therefore, a plurality of sets of stored content data are readily accessible. For example, if sets of content data are stored in the order of reception, the sets of content data stored in the content, data list are sequentially switchable.

The content data output device of the present invention is preferably adapted so that the device is capable of reproducing a video; and further includes switching means which, if content data is received during the video reproduction, switches from the video reproduction to the output of the content data.

The configuration includes switching means which, if the content data is received while the video is being reproduced, switches from the video reproduction to the output of the content data. Therefore, the content data is automatically viewable without the user having to switch between sources on the device or stopping the video reproduction to view the content data while the video is being reproduced.

The content data output device of the present invention is preferably adapted so that: the content data output device is capable of outputting television broadcast; and the device further includes switching means for, if the content data is received while the content data output device is outputting television broadcast, switching the output from a television broadcast channel to a content data channel through which the content data is output.

The configuration includes switching means which, when the content data is received, automatically switches from a television broadcast channel to a content data channel. Therefore, the content data is automatically viewable without the user having to switch between sources on the device during the television broadcast.

The content data output device of the present invention, as described in the foregoing, includes: content data receiving means for receiving content data; and content data control means for storing the content data received by the content data receiving means implementing such control as to output the recorded content data in preference to other data. Therefore, the content data is output by simply transmitting the content data to the content data output device. The user is required no operation at all on the content data output device and does not bother to connect the content data transmitting device to the content data output device.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

The data, output device is particularly suited for applications to wide-screen televisions, DVD recorders, and HDD recorders.

1-22. (canceled)

23. A content data output device, comprising:
content data receiving means for receiving content data by short distance wireless communications; and
content data control means for implementing such control as to record the content data received by the content data receiving means while outputting other data and to output the recorded content data in preference to the other data.

24. A content data output device, comprising:
content data receiving means for receiving content data from an external device; and
content data control means for implementing such control as to record the content data received by the content data receiving means while outputting other data and to output the recorded content data in preference to the other data in order to provide the recorded content data to a user who has operated the external device.

25. The content data output device of claim 23, further comprising status detection processing means which, when the content data is received, either detects a status of the content data output device or receives an instruction from a transmitting end of the content data, in order to perform a predetermined process in accordance with the status detected or the instruction received.

26. The content data output device of claim 25, wherein:
either the content data output device or a device connected to the content data output device is capable of reproducing a video; and
the status detection processing means, if the video is being reproduced when the content data is received, either stops or pauses the reproduction of the video.

27. The content data output device of claim 28, wherein the status detection processing means, when the output of the content data ends, releases the video from the stop or the pause.

28. The content data output device of claim 25, wherein:
the content data output device is capable of outputting television broadcast; and the status detection processing means, if the content data output device is outputting television broadcast when the content data is received, starts recording the television broadcast.

29. The content data output device of claim 28, wherein the status detection processing means, when the output of the content data ends, starts reproducing the television recording.

30. A content data output device, comprising:
content data receiving means for receiving content data by short distance wireless communications;
content data control means for controlling output of the content data; and
designated program storage means for storing broadcasting hours of a designated television program, wherein:
the content data control means implements such control as to store the received content data, but not to output the content data if a television program stored in the designated program storage means is being output when the content data receiving means receives the content data, and implements such control as to store the content data received by the content data receiving means and to output the recorded content data in preference to other data if data other than the television program stored in the designated program storage means is being output when the content data receiving means receives the content data.

31. A content data output device, comprising:
content data receiving means for receiving content data from an external device;
content data control means for controlling output of the content data; and
designated program storage means for storing broadcasting hours of a designated television program,
wherein:
the content data control means implements such control as to store the received content data, but not to output the content data if a television program stored in the designated program storage means is being output when the content data receiving means receives the content data, and implements such control as to store the content data received by the content data receiving means and to output the recorded content data in preference to other data in order to provide the recorded content data to a user who has operated the external device if data other than the television program stored in the designated program storage means is being output when the content data receiving means receives the content data.

32. The content data output device of claim 30, further comprising content data storage means for storing the content data received by the content data receiving means, wherein after the broadcasting hours of the designated television program, the content data that is stored in the content data storage means, but yet to be output, starts to be output.

33. The content data output device of claim 23, further comprising content data storage means for storing the content data received by the content data receiving means, wherein the content data control means sequentially outputs the content data stored in the content data storage means at a time interval.

34. The content data output device of claim 23, wherein the content data control means, if the content data receiving means have collectively received a plurality of sets of content data, outputs the received plurality of sets of content data either partially or entirely in a single screen.

35. The content data output device of claim 23, wherein the content data control means, if the content data receiving means has collectively received a plurality of the content data, sequentially outputs the received plurality of the content data at a time interval.

36. The content data output device of claim 23, further comprising content data storage means for storing the content data received by the content data receiving means, wherein the content data control means includes content data erasing means for erasing the content data stored in the content data storage means according to a predetermined set of conditions.

37. The content data output device of claim 23, wherein:
the content data output device is capable of outputting television broadcast; and
a list of channels for the television broadcast contains a list for the content data so that the content data is selectable by switching between the channels for the television broadcast.

38. The content data output device of claim 37, wherein:
a set of content data is designated from the list for the content data; and
the designated set of content data is selectable.

39. The content data output device of claim 23, wherein:
the content data receiving means discriminates between directions from which sets of content data have been transmitted; and
the content data output means is capable of displaying each set of content data in a different direction so that each set of content data is not displayed in an opposite direction to a direction from which that set of content data has been transmitted.

40. The content data output device of claim 23, wherein:
the content data receiving means discriminates between directions from which sets of content data have been transmitted; and
the content data output means is capable of displaying each set of content data in a different direction so that any set of received content data is viewable from any direction.

41. A television, comprising the content data output device of claim 39.
